(19) United States
(12) Patent Application Publication
(10) Pub. No.: US 2012/0310411 A1
(43) Pub. Date: Dec. 6, 2012

(54) ROBOT APPARATUS AND METHOD FOR CONTROLLING THE SAME

(75) Inventors: Toshimitsu TSUBOI, Tokyo (JP); Akichika Tanaka, Chiba (JP); Hirokazu Shirado, Tokyo (JP); Yoshiaki Iwai, Tokyo (JP); Atsushi Miyamoto, Kanagawa (JP)

(73) Assignee: Sony Corporation, Tokyo (JP)

(21) Appl. No.: 13/466,497

(22) Filed: May 8, 2012

(30) Foreign Application Priority Data
May 31, 2011 (JP) 2011-122908

(51) Int. Cl. G06F 19/00

(52) U.S. Cl. 700/245

(57) ABSTRACT

Provided is a robot apparatus including actuators for driving joint shafts and measuring at least one of a joint angle and a joint angle speed of each of the joint shafts, and a central control part for controlling each of the actuators, wherein the central control part performs a periodic communication at predetermined control periods and the periodic communication includes transmitting a desired control value from the central control part to each of the actuators and transmitting a measured value from each of the actuators to the central control part, the central control part stops the periodic communication in response to an occurrence of an actuator that has failed to receive the measured value during a given period of time, and each of the actuators performs a safety stop in response to an event where the actuator has not received the desired control value during a given period of time.

### BACKGROUND

The present disclosure relates to a robot apparatus that behaves according to periodic communications between a central control part and an actuator of each joint shaft and a method for controlling the robot apparatus, and particularly relates to a robot apparatus that ensures the safety of the behavior when the periodic communication is lost and a method for controlling the robot apparatus. The central control part indicates a desired control value. The actuator drives each joint according to the desired control value.

In a rapidly aging society, an aged individual preferably stays healthy without a nursing care as long as possible and it is also preferable that an aged individual can independently live without worsening the condition if he or she is in a condition of need for a nursing care. In the future, attendance on one aged individual by one helper will cause the shortage of the number of helpers as there is a growing need for a nursing care or a support for housekeeping. Accordingly, there is a growing need for a mechatronic device such as a robot to act for a housekeeper or a care worker among elder care facilities and homes having an aged individual. In other words, there is an urgent need to ensure the safety of a robot working in a living space, coupled with the assumption that a robot deeply pervades a living space.

In the case of an industrial robot, separating the working area with a fence generally ensures the safety. However, separating the working area with a fence is difficult in the case of a housekeeping or nursing care robot because the robot behaves while physically in contact with an individual.

A general industrial robot arm or the like brakes when powered off and stops the behavior to maintain the posture in order to ensure the safety. In this case, the safety means preventing the arm from dropping under the force of gravity and damaging the surroundings. However, the robot arm itself becomes a projection from the floor or the wall when fixed by the brake while the robot arm is powered off. This causes a risk that the fixed robot arm collides with a person when the person approaches.

A robot in the past is often of a position control type that gives an angle instruction value to the actuator for driving a joint and drives a joint according to the instruction value. The position control type robot is weak in a “soft” control for the force or the acceleration although being easily controlled. On the other hand, the applicant considers that a robot serving a more flexible physical interaction with a person as a nursing care or housekeeping is preferably of a force control type that gives a torque instruction value to the actuator for driving a joint and drives a joint according to the instruction value. The force control type robot can directly control the force by directly controlling the generating force at a joint.

For example, Japanese Patent Application Laid-Open No. 10-329071 discloses an impedance control apparatus for a robot arm that can decrease the restoring force when a large force acts on the arm to increase the safety, and can increase the restoring force when a small force acts on the arm to ensure the motion accuracy, by directly detecting a contact force between the robot arm and a person (or an object) and using information about the contact force (refer to the Japanese Patent Application Laid-Open No. 10-329071).

A robot generally controls the force or the position according to the communication between the central control part 400 and the driving part of each joint actuator at predetermined control periods. When the periodic communication between the central control part 400 and the driving part of each joint actuator is lost, the central control part 400 fails to obtain a value of torque generated at the joint or the current position information of the joint, and the driving part of the joint actuator fails to receive a instruction value from the central control part 400. Accordingly, the central control part 400 fails to control the drive of the joint actuator.

In the above-mentioned impedance control apparatus for a robot arm, the central control part 400 controls the drive of the joint actuator on the assumption that the periodic communication can be done. For example, the torque value needs to be changed according to the posture when a force control type robot controls the drive of the joint actuator. When the periodic communication is lost in this case, the torque instruction value of the joint shaft losing the communication becomes constant. This causes the joint shaft to lose the balance and yield to the force of gravity or to rotate against the force of gravity when the posture is changed for some reasons. A constant torque instruction value does not maintain the position so that the posture increasingly loses the balance. Accordingly, the actuator is in danger of going out of control. In other words, the impedance control apparatus may not ensure the safety while a periodic communication is lost.

### SUMMARY

It is desirable to provide an excellent robot apparatus and a method for controlling the robot apparatus. The robot apparatus can properly behave according to the periodic communication between the central control part indicating a desired control value and the actuator of each joint shaft driven according to the desired control value.

It is furthermore desirable to provide an excellent robot apparatus and a method for controlling the robot apparatus. The robot apparatus can ensure the safety of the behavior in the case where the periodic communication is lost.

In view of the foregoing needs, according to an embodiment of the present disclosure, there is provided a robot apparatus including actuators for driving joint shafts and measuring at least one of a joint angle and a joint angle speed of each of the joint shafts, and a central control part for controlling each of the actuators. The central control part performs a periodic communication at predetermined control periods and the periodic communication includes transmitting a desired control value from the central control part to each of the actuators and transmitting a measured value from each of the actuators to the central control part, the central control part stops the periodic communication in response to an occurrence of an actuator that has failed to receive the measured value during a given period of time in the periodic communication, and each of the actuators performs a safety stop in response to an event where the actuator has not received the desired control value in the periodic communication during a given period of time.

According to another embodiment of the present disclosure, there is provided a robot apparatus including actuators for driving joint shafts and measuring torque and at least one of a joint angle and a joint angle speed of each of the joint shafts, and a central control part for controlling each of the actuators. The central control part performs a periodic communication at predetermined control periods and the periodic communication includes transmitting a desired control value from the central control part to each of the actuators and transmitting a measured value from each of the actuators to the central control part, the central control part stops the periodic communication in response to an occurrence of an actuator that has failed to receive the measured value during a given period of time in the periodic communication, and each of the actuators performs a safety stop in response to an event where the actuator has not received the desired control value in the periodic communication during a given period of time.

According to the embodiments of the present disclosure described above, each of the actuators may approximate a desired angle speed value to zero in time order under an angle speed control mode, may also approximate a speed control gain to zero in time order, and then may stop a servo as the safety stop.

According to the embodiments of the present disclosure described above, the robot apparatus may further include an arm part. Each of the actuators may include a brake part for maintaining a rotation angle at the safety stop, and the brake part does not maintain the rotation angle of an actuator of which rotation axis direction corresponds with the direction of gravity at the safety stop although the brake part maintains the rotation angle of an actuator of which rotation axis direction does not correspond with the direction of gravity, and the actuators may be included in the arm part.

According to the embodiments of the present disclosure described above, each of the actuators may include a brake part for maintaining a rotation angle at the safety stop, the central control part may find an angle value to safely stop each of the actuators and a predetermined value for a safety stop indicating an ON/OFF of the brake part and performs the periodic communication to transmit the values, and each of the actuators may update the predetermined value for a safety stop at each periodic communication to perform the safety stop according to the predetermined value for a safety stop.

According to another embodiment of the present disclosure, there is provided a method for controlling a robot apparatus, including performing a periodic communication between actuators and a central control part, the periodic communication including transmitting a desired control value from the central control part to each of the actuators and transmitting a measured value from each of the actuators to the central control part at predetermined control periods, each of the actuators driving a joint shaft and also measuring at least one of a joint angle and a joint angle speed of the joint shaft, the central control part controlling each of the actuators, stopping, by the central control part, a periodic communication in response to an occurrence of an actuator that has failed to receive the measured value for a given period of time in the periodic communication; and performing a safety stop in response to an event where the actuator has not received the desired control value during a given period of time in the periodic communication.

According to another embodiment of the present disclosure, there is provided a method for controlling a robot apparatus, including performing a periodic communication between actuators and a central control part, the periodic communication including transmitting a desired control value from the central control part to each of the actuators and transmitting a measured value from each of the actuators to the central control part at predetermined control periods, each of the actuators driving a joint shaft and also measuring at least one of a joint angle and a joint angle speed of the joint shaft, the central control part controlling each of the actuators, stopping, by the central control part, a periodic communication in response to an occurrence of an actuator that has failed to receive the measured value for a given period of time in the periodic communication, and performing a safety stop in response to an event where the actuator has not received the desired control value during a given period of time in the periodic communication.

According to the technique disclosed herein, an excellent robot apparatus and a method for controlling the robot apparatus can be provided. The robot apparatus can ensure the safety of the behavior even if the periodic communication between the central control part that indicates a desired control value and the actuator of each joint shaft that drives according to the desired control value is lost.

These and other purposes, features, and advantages of the technique disclosed herein will be understood upon examining the figures and reading the following detailed description of the embodiments of the disclosure.

### BRIEF DESCRIPTION OF THE DRAWINGS

FIG. 1 is a view of the appearance of a robot apparatus 100 capable of using a technique disclosed herein;

FIG. 2 is a pattern diagram showing a degree of freedom structure of the joints of the robot apparatus 100 capable of using a technique disclosed herein;

FIG. 3 is a pattern diagram of an exemplary structure of an actuator 300 placed at each joint of the robot apparatus 100 shown in FIGS. 1 and 2;

FIG. 4 is a view of an exemplary structure of a central control part 400 generally controlling the behaviors of the whole robot apparatus 100 shown in FIGS. 1 and 2;

FIG. 5 is a flowchart showing the procedures of a periodic communication of the whole body by the central control part 400;

FIG. 6 is a flowchart showing the procedures of a periodic communication executed by the actuator 300 of each shaft;

FIG. 7 is a flowchart showing the procedures of a safety stop independently executed by the actuator 300 of each shaft;

FIG. 8 is a view of an exemplary structure of the actuator 300 including a brake part 308;

FIG. 9A is a view of the robot apparatus 100 shown in FIG. 1 horizontally holding an object 120 at elbow level with its right hand;

FIG. 9B is a view of the robot apparatus 100 shown in FIG. 1 failing to horizontally hold the object 120 at elbow level with its right hand because the robot apparatus 100 does not maintain a rotation angle with respect to the actuator 300 of which rotation axis direction does not correspond with the direction of gravity;

FIG. 10A is a view of the robot apparatus 100 horizontally holding the object 120 at shoulder level with its right hand;

FIG. 10B is a view of the robot apparatus 100 failing to horizontally hold the object 120 at shoulder level with its right hand because the robot apparatus 100 does not maintain a rotation angle with respect to the actuator 300 of which rotation axis direction does not correspond with the direction of gravity;

FIG. 11A is a view of the robot apparatus 100 shown in FIG. 1 horizontally holding the object 120 at shoulder level with its right hand;

FIG. 11B is a view of the robot apparatus 100 failing to horizontally hold the object 120 at shoulder level with its right hand because the robot apparatus 100 does not maintain a rotation angle with respect to the actuator 300 of which rotation axis direction does not correspond with the direction of gravity;

FIG. 12 is a view of an exemplary structure of the central control part 400 generally controlling the behaviors of the whole robot apparatus 100 shown in FIGS. 1 and 2;

FIG. 13 is a flowchart showing the procedures of a periodic communication of the whole body by the central control part 400;

FIG. 14 is a flowchart showing the procedures of a periodic communication executed by the actuator 300 of each shaft; and

FIG. 15 is a flowchart showing procedures of a safety stop independently executed by the actuator 300 of each shaft.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

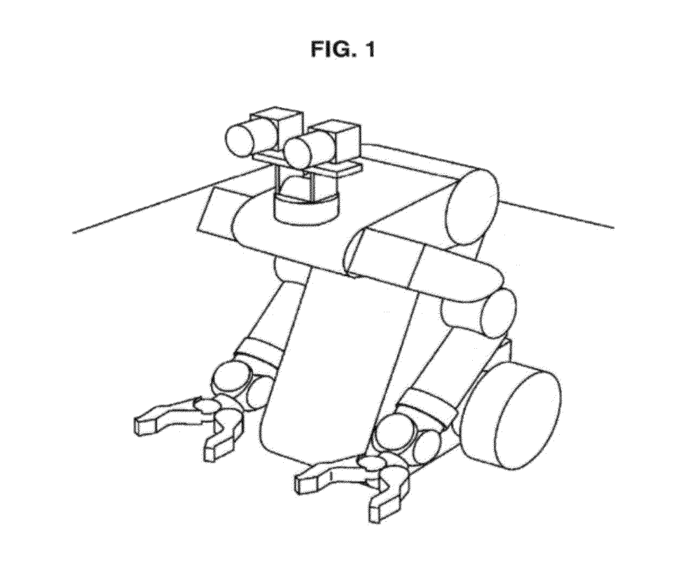

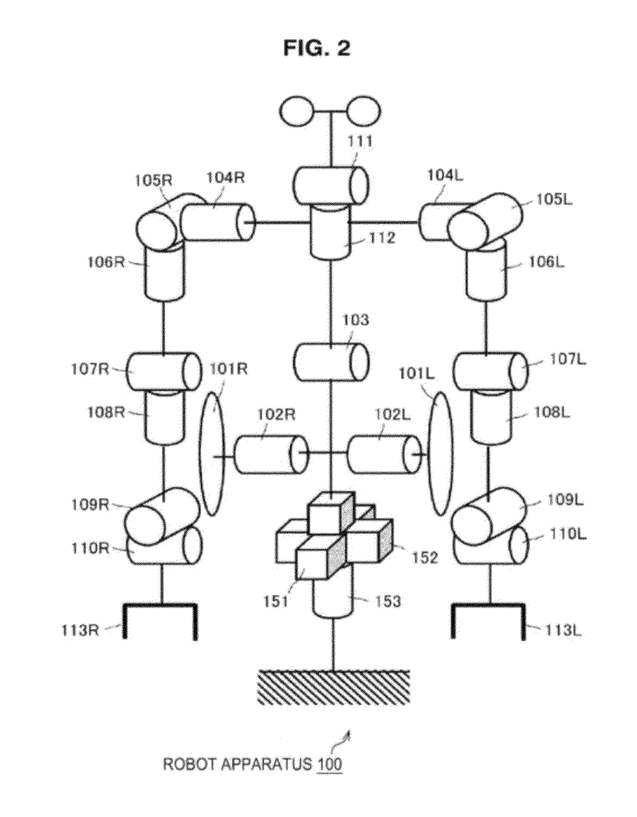

FIG. 1 shows the appearance of a robot apparatus 100 capable of using the technique disclosed herein. The robot apparatus 100 is a link structure in which a plurality of links is connected to each other with joints. Each of the joints is operated by the actuator. FIG. 2 schematically shows a degree of freedom structure of the joints of the robot apparatus 100. The robot apparatus 100 shown in FIGS. 1 and 2 can be used for various purposes such as for industrial use although mainly provided at home and performing housekeeping or a nursing care.

The robot apparatus 100 shown in FIGS. 1 and 2 has, as transportation, two driving wheels 101R and 101L opposite to a base part. The driving wheels 101R and 101L are driven by actuators 102R and 102L that are for the driving wheels and rotate in a pitch direction, respectively. Note that, in FIG. 2, reference numerals 151, 152, and 153 denote virtual underactuated joints and also denote translational degrees of freedom in an X-direction (front-back direction), translational degrees of freedom in a Y-direction (right-left direction), and yaw rotational degrees of freedom of the robot apparatus 100 relative to the floor surface, respectively to explain that the robot apparatus 100 moves around the virtual world.

The driving wheels are coupled to the upper body through a waist joint. The waist joint is driven by a waist joint pitch-axis actuator 103 that rotates around the pitch axis. The upper body includes two right and left arm parts and a head part coupled through a neck joint. The right and left arm parts have three degrees of freedom of the shoulder joint, two degrees of freedom of the elbow joint, and two degrees of freedom of the wrist joint, totaling seven degrees of freedom. The three degrees of freedom of the shoulder joint are driven by shoulder joint pitch-axis actuators 104R/104L, shoulder joint roll-axis actuators 105R/105L, and shoulder joint yaw-axis actuators 106R/106L. The two degrees of freedom of the elbow joint are driven by elbow joint pitch-axis actuators 107R/107L and elbow joint yaw-axis actuators 108R/108L. The two degrees of freedom of the wrist joint are driven by wrist joint roll-axis actuators 109R/109L and wrist joint pitch-axis actuators 110R/110L. The two degrees of freedom of the neck joint are driven by a neck joint pitch-axis actuator 111 and a neck joint yaw-axis actuator 112. One degree of freedom of the hand joint is driven by hand joint roll-axis actuators 113R/113L.

Note that the gist of the technique disclosed herein is not limited to the opposed-two-wheeled transportation although the robot apparatus 100 shown in FIGS. 1 and 2 has the opposed-two-wheeled transportation. For example, the technique disclosed herein can be also applied to a robot apparatus 100 having leg-type transportation in the same manner.

The actuator of each shaft is equipped with an encoder for measuring the joint angle, a motor for generating torque, a current-controlled motor driver for driving the motor, and a reducer for obtaining a sufficient generating force. The actuator is also provided with a microcomputer for controlling the drive of the actuator (none of these shown in FIG. 2).

A host computer (described below) generally controls the behaviors of the whole robot apparatus 100. The host computer can communicate with the microcomputer of each shaft so that the desired torque value of the actuator of each shaft can be transmitted from the host computer. The microcomputer of each shaft can transmit the current output torque, joint angle, and joint angle speed of the actuator to the host computer. The host computer performs a control operation for coordinating the whole body to calculate the desired torque value for every joint.

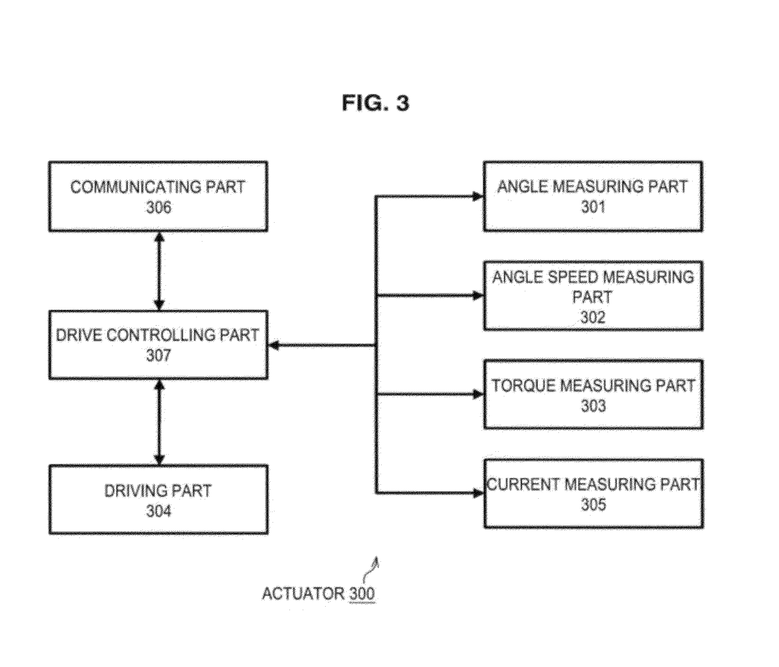

FIG. 3 schematically shows an exemplary structure of an actuator 300 placed at each joint of the robot apparatus 100 shown in FIGS. 1 and 2. The actuator 300 of each shaft is equipped with an angle measuring part 301 for measuring the joint angle, an angle speed measuring part 302 for measuring the joint angle speed, a torque measuring part 303 for measuring the action on the surroundings or an individual, a motor (driving part 304) for generating torque, a current-controlled motor driver (driving part 304 and current measuring part 305) for driving the motor, and a reducer (driving part 304) for obtaining a sufficient generating force. The actuator 300 is also provided with a drive controlling part 307 that controls the drive of the driving part 304 and includes a microcomputer. The drive controlling part 307 can, for example, receive an instruction to drive the actuator 300 from the host computer through a communicating part 306 and transmit sensor information including a joint angle, a joint angle speed, and a current value to the host computer.

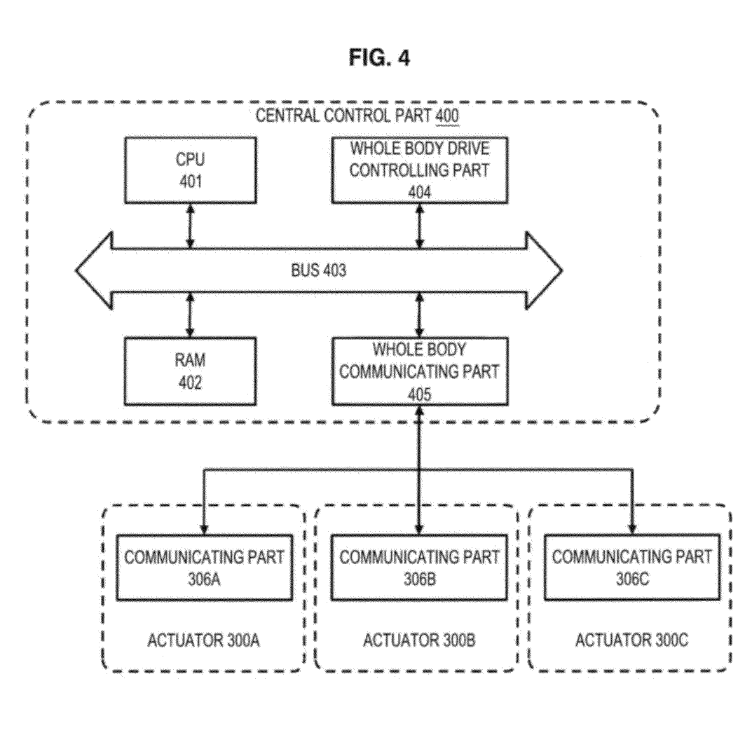

FIG. 4 shows an exemplary structure of the central control part 400 that generally controls the behaviors of the whole robot apparatus 100 shown in FIGS. 1 and 2. A central processing unit (CPU) 401 as the host computer generally controls the behaviors of the whole robot apparatus 100 through a bus 403.

A whole body communicating part 405 of the central control part 400 intercommunicates with the communicating part 306 of the actuator 300 of each shaft through, for example, a wired local area network (LAN) such as an Ethernet (registered trademark), a general interface such as a universal serial bus (USB), or a wireless LAN specified by IEEE802.11 or the like. The CPU 401 can give the desired torque value of the actuator 300 of each shaft because the CPU 401 can communicate with the microcomputer (drive controlling part 307) in the actuator 300 of each shaft through the whole body communicating part 405 and the communicating part 306 of each shaft. The microcomputer of each shaft can transmit the current output torque, joint angle, and joint angle speed of the actuator 300 to the CPU 401. Then, the CPU 401 executes a program expanded into a random access memory (RAM) 402 and performs, together with a whole body drive controlling part 404, a control operation for coordinating the whole body to calculate the desired torque value for every joint.

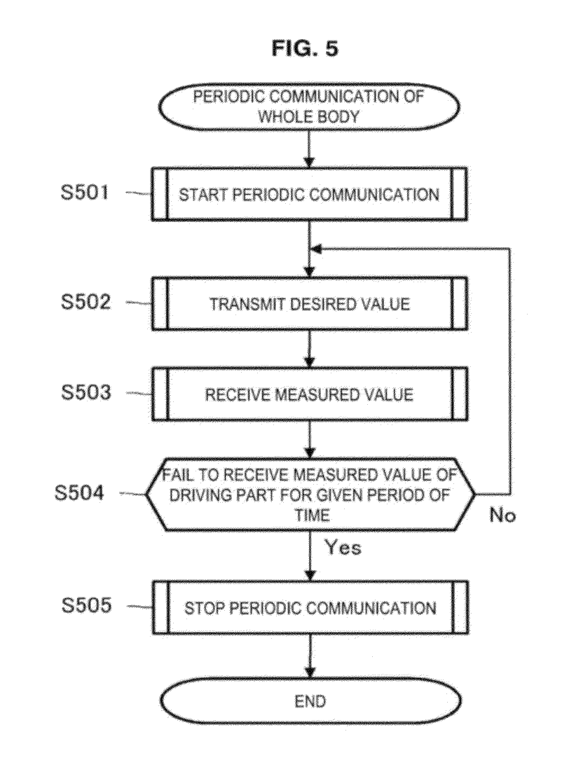

The whole body communicating part 405 can communicate with the microcomputer in the actuator 300 of each shaft through the communicating part 306 of each shaft. The whole body communicating part 405 performs a periodic communication of the whole body at each predetermined interval of the control to transmit a desired control value such as a desired torque value and receive the measured values such as an angle, angle speed, and torque of a joint shaft. FIG. 5 is a flowchart showing procedures of a periodic communication of the whole body by the central control part 400.

The whole body communicating part 405 starts a periodic communication in step S501. After the start of the periodic communication, the process goes to step S502.

The central control part 400 performs a periodic communication to transmit a desired value to the actuator 300 of each shaft in step S502.

Next, the central control part 400 performs a periodic communication to receive the measured values such as an output torque, a joint angle, and a joint angle speed from the actuator 300 of each shaft in step S503.

Next, the central control part 400 determines in step S504 whether the central control part 400 has failed to receive the measured values such as an output torque, a joint angle, and a joint angle speed from the actuator 300 during a given period of time. The central control part 400 detects the failure to receive the measured values when the central control part 400 has failed to receive the measured values from at least one of the actuators 300 for a given period of time, or the count value that is included in the received result and is supposed to change every time has not been updated although the central control part 400 has received the measured values.

When the central control part 400 can receive the measured values from every actuator 300 (“No” in step S504), the process goes back to step S502. On the other hand, when the central control part 400 detects the failure to receive the measured values from at least one of the actuators 300 (“Yes” in step S504), the process goes to step S505.

The central control part 400 stops the periodic communication in step S505. When finding a joint shaft that fails to communicate, namely, a joint shaft that fails to receive the desired value, the central control part 400 stops the periodic communication of the whole body because of danger. Once the periodic communication is stopped, a safety stop starts in the actuator 300 of each joint shaft as described below.

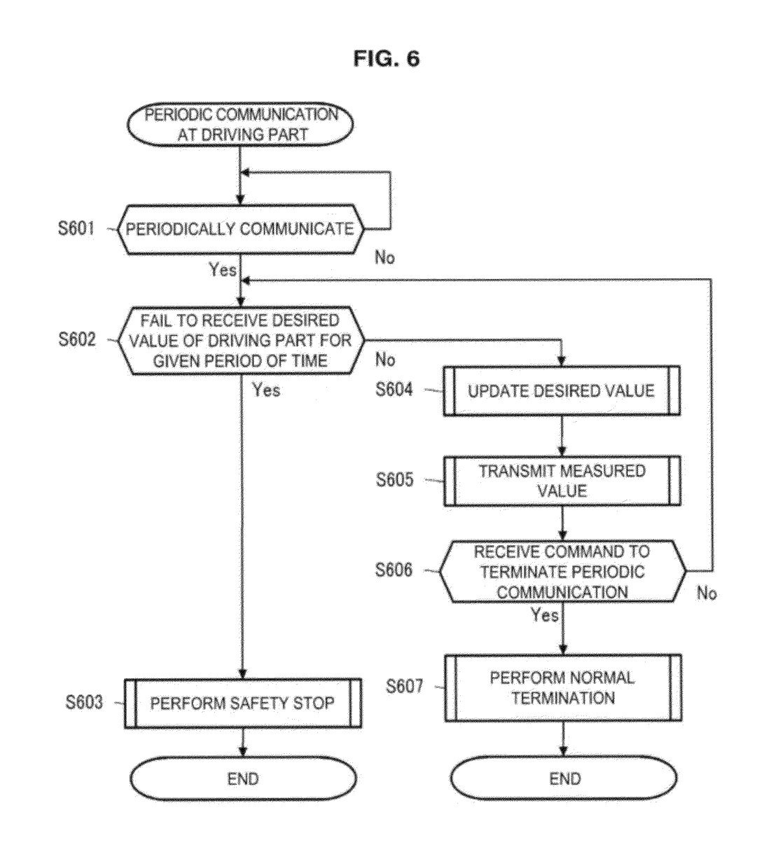

FIG. 6 is a flowchart showing procedures of a periodic communication executed by the actuator 300 of each shaft in response to the periodic communication of the whole body by the central control part 400.

First, the actuator 300 of each shaft determines in step S601 whether a periodic communication has started. When a periodic communication has not started (“No” in step S601), the process goes back to step S601 to wait for the start of a periodic communication. On the other hand, when a periodic communication has started (“Yes” in step S601), the process goes to step S602.

The actuator 300 of each shaft determines in step S602 whether the actuator 300 of each shaft has failed to receive the desired torque value of the driving part 304 from the central control part 400 during a given period of time at the periodic communication. When the actuator 300 of each shaft has received the desired torque value of the driving part 304 from the central control part 400 (“No” in step S602), the process goes to step S604 as a normal reception has been done.

The actuator 300 updates its desired torque value with the latest value received from the central control part 400 as a normal reception in step S604. The actuator 300 then measures an angle, angle speed, and torque of the joint shaft and transmits the measured values to the central control part 400 in step S605.

Next, the actuator 300 determines in step S606 whether the actuator 300 has received a command to terminate the periodic communication from the central control part 400. The process then goes back to step S602 to continue the periodic communication with the central control part 400 when the actuator 300 has not received the command to terminate the periodic communication from the central control part 400 (“No” in step S606). On the other hand, the process goes to step S607 when the actuator 300 has received the command to terminate the periodic communication from the central control part 400 (“Yes” in step S606).

A normal termination is performed in step S607. Specifically, the actuator 300 performs a normal termination, receiving a desired torque value or a desired positional value necessary to perform the normal termination from the central control part 400.

On the other hand, the process goes to step S603 when the actuator 300 of each shaft has failed to receive the desired torque value from the central control part 400 during a given period of time at the periodic communication (“Yes” in step S602). A safety stop is carried out when the actuator 300 fails to communicate with the central control part 400 in step S603. The actuator 300 of each shaft independently performs a safety stop when failing to communicate with the central control part 400.

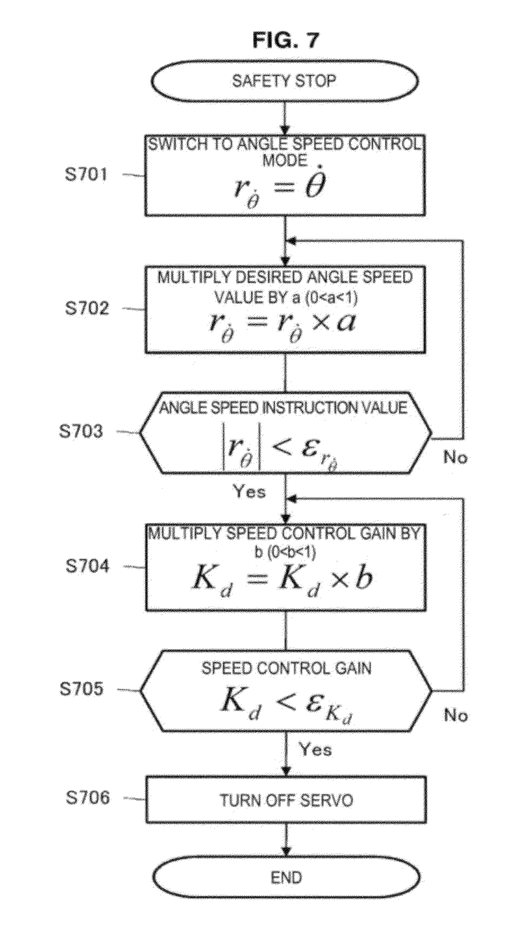

FIG. 7 is a flowchart showing procedures of a safety stop independently executed by the actuator 300 of each shaft in step S603 of the flowchart shown in FIG. 6.

After the start of a safety stop, the current angle speed is substituted into the current desired angle speed value as shown in the following expression (1) to switch the control mode from the torque control mode to the speed control mode in step S701 (the left-hand side denotes the desired angle speed value and the right-hand side denotes the current angle speed in the following expression (1)).

r_{\dot{θ}}=\dot{θ} (1)

The speed is maintained when the control mode is switched to the speed control mode. The speed is exponentially reduced in the subsequent procedures. Accordingly, this can realize smooth behaviors even though each actuator independently behaves.

To stop the behavior of the robot apparatus 100, the desired angle speed value is approximated to zero in time order in step S702. Specifically, the desired angle speed value is multiplied by a constant a (where 0>a>1) one time each control period as shown in the following expression (2) to approximate the desired angle speed value to zero.

r_{\dot{θ}}=r_{\dot{θ}}×α (2)

The actuator 300 then determines at each control period in step S703 whether the absolute value of the calculated desired angle speed value has been sufficiently approximated to zero. When the absolute value of the desired angle speed value is larger than a sufficiently small positive number ε_{rθ} (“No” in step S703), the process goes back to step S702 to repeat further approximating the desired angle speed value to zero.

The process goes to step S704 when the absolute value of the desired angle speed value is smaller than a sufficiently small positive number ε_{rθ} as shown in the following expression (3) (“Yes” in step S703). Repeating steps S702 and S703 can stop the behavior of the robot apparatus 100.

|r_{\dot{θ}}|<εᵣ_{_{\dot{θ}}} (3)

The procedure in step S704 is carried out, for example, to slowly put down the arm part of the robot apparatus 100 that has been stopped. Specifically, the actuator 300 approximates the control gain K_{d} of the speed control to zero in time order to gradually increase the deviation under the force of gravity. In other words, the control gain K_{d} is multiplied by a constant b (where 0<b<1) one time each control period as shown in the following expression (4) to approximate the control gain K_{d} to zero.

K_{d}=K_{d}×b (4)

The actuator 300 then determines each control period in step S705 whether the calculated control gain K_{d} has been sufficiently approximated to zero. The process then goes back to step S704 to repeat further approximating the control gain K_{d} to zero when the control gain K_{d} is larger than a sufficiently small positive number ε_{Kd} (“No” in step S705). Repeating steps S704 and S705 can, for example, slowly put down the arm part of the robot apparatus 100.

The process goes to step S706 when the control gain K_{d} is smaller than a sufficiently small positive number ε_{Kd} as shown in the following expression (5) (“Yes” in step S705).

K_{d}<ε_{K}_{_{d}} (5)

The actuator 300 turns off a servo of the actuator 300 to stop generating the torque in order to completely exhaust the arm part in step S706.

A safety stop described with reference to FIGS. 4 to 7 is for finally completely exhausting the arm part of the robot apparatus 100 to prevent the arm from dropping under the force of gravity. The safety stop is efficient when applied to the arm part of the robot apparatus 100 that does not hold an object.

On the other hand, when the arm part is completely exhausted in response to a safety stop as shown in FIG. 7 while the robot apparatus 100 holds an object with the arm part, the held object is in danger of dropping. Accordingly, it is necessary to maintain the posture of the arm part for a safety stop when the robot apparatus 100 holds an object with the arm part. However, when the stopped robot apparatus 100 maintains the posture of the arm part in a living environment, there is danger that an individual may collide with or stumble on the arm part. In view of the foregoing, in order for the arm to slip out of the collision, the robot apparatus maintains a shaft that includes an actuator 300 of which rotation axis direction does not correspond with the direction of gravity, and does not maintain a shaft that includes an actuator 300 of which rotation axis direction corresponds with the direction of gravity. This can decrease the shock of the collision.

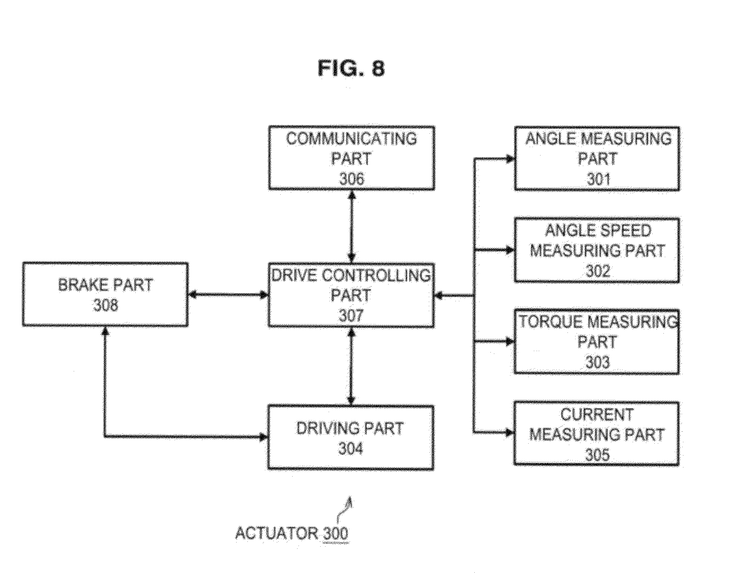

Providing the actuator 300 with a brake part for maintaining a shaft is given as an exemplary method for maintaining a shaft. FIG. 3 shows an exemplary structure of an actuator 300 placed at each joint of the robot apparatus 100 shown in FIGS. 1 and 2. FIG. 8 shows an exemplary structure of the actuator 300 including a brake part 308 as a modification. The brake part 308 is activated in response to an instruction from the drive controlling part 307 to maintain the position of the driving part 304. The brake part 308 includes, for example, an electromagnetic brake so that the position of the driving part 304 is maintained even while the robot apparatus 100 is powered off.

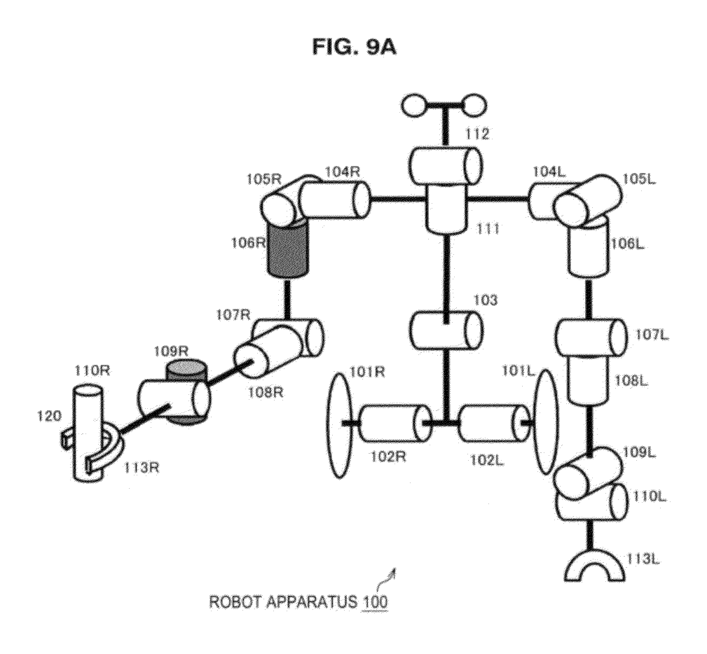

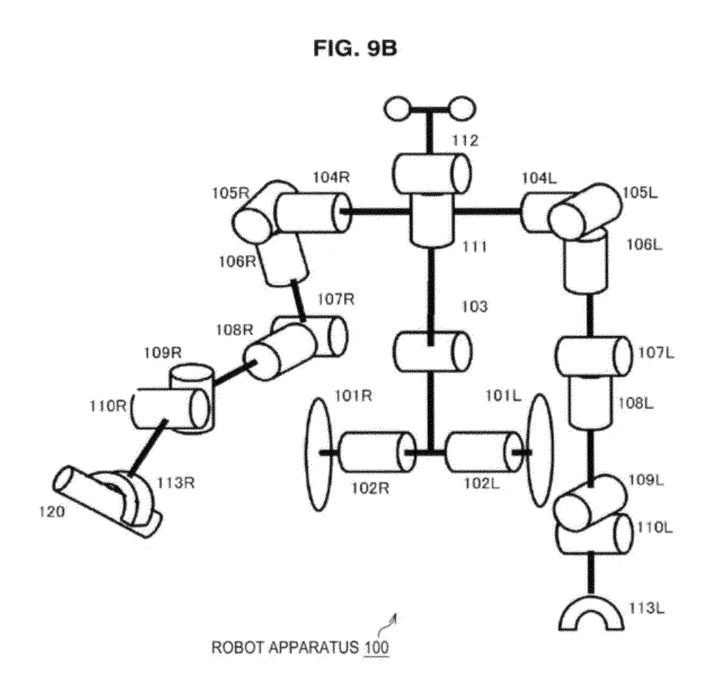

FIG. 9A shows the robot apparatus 100 shown in FIG. 1 horizontally holding an object 120 at elbow level with its right hand. The robot apparatus 100 holds the object 120 with its right hand, putting the object in the hand joint roll-axis actuator 113R as shown in FIG. 9A. The elbow joint pitch-axis actuator 107R rotates only 90 degrees from a vertical direction to horizontally maintain the forearm part from the elbow joint to the tip. The other joints are at the same angles as those shown in FIG. 1.

The posture of the robot apparatus 100 shown in FIG. 9A is one of basic safety stop postures. In this case, the basic safety stop posture means a posture where some brake parts 308 hold their actuators 300 so that a basic holding posture can be maintained. More specifically, the basic safety stop posture of the right arm means a posture where the rotation axis direction of at least one actuator 300 of the joint shafts constituting the right arm corresponds with the direction of gravity. Rotating the actuator of which rotation axis direction corresponds with the direction of gravity enables the arm to slip out of external force while the robot apparatus horizontally holds the object at the same level.

In the case shown in FIG. 9A, the rotation axis directions of the following actuators do not correspond with the direction of gravity: the shoulder joint pitch-axis actuator 104R, the shoulder joint roll-axis actuator 105R, the elbow joint pitch-axis actuator 107R, the elbow joint yaw-axis actuator 108R, the wrist joint pitch-axis actuator 110R, and the hand joint roll-axis actuator 113R. Then, maintaining the actuators 104R, 105R, 107R, 108R, 110R, and 113R at the angle shown in FIG. 9A can maintain a basic holding posture. On the other hand, both of the shoulder joint yaw-axis actuator 106R and the wrist joint roll-axis actuator 109R do not maintain the rotation angles because the rotation axis directions of both actuators corresponds with the direction of gravity (the actuators which do not maintain the rotation angle are shown in gray in FIG. 9A). Accordingly, when external force acts on the right arm, the actuators 106R and 109R rotate around the rotation axis to enable the right arm to slip out of the external force while horizontally holding the object 120 at elbow level. This can soften the shock of the collision with an individual or an object.

Note that the actuator of which rotation axis direction does not correspond with the direction of gravity such as the actuator 104R preferably maintains the rotation angle, otherwise it would be difficult for the right arm to hold the object 120 at elbow level or horizontally as shown in FIG. 9B.

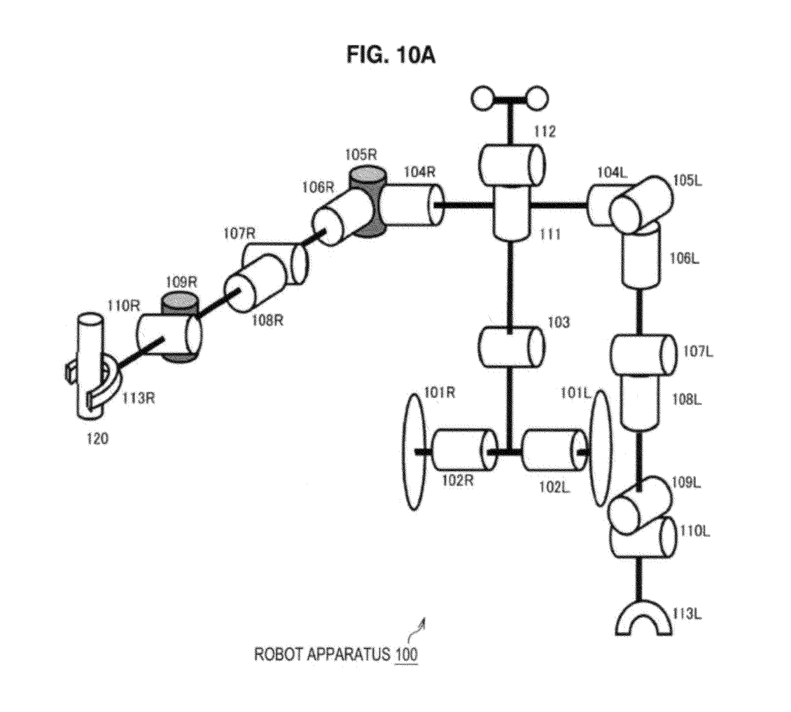

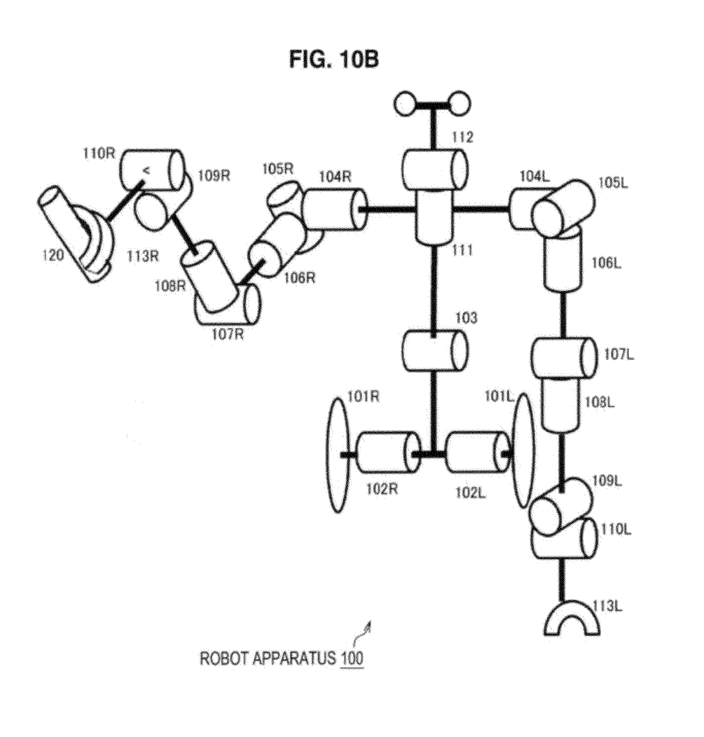

FIG. 10A shows the robot apparatus 100 horizontally holding the object 120 at shoulder level with its right hand. The robot apparatus 100 holds the object 120 with its right hand, putting the object 120 in the hand joint roll-axis actuator 113R as shown in FIG. 10A. The shoulder joint pitch-axis actuator 104R rotates only 90 degrees from a vertical direction to horizontally maintain the arm part from the shoulder joint to the tip. The other joints are at the same angles as those shown in FIG. 1.

The posture of the robot apparatus 100 shown in FIG. 10A is also one of basic safety stop postures because the rotation axis direction of at least one of the actuators corresponds with the direction of gravity. The actuators constitute the right arm that holds the object. In the case shown in FIG. 10A, the rotation axis directions of the following actuators do not correspond with the direction of gravity: the shoulder joint pitch-axis actuator 104R, the shoulder joint yaw-axis actuator 106R, the elbow joint pitch-axis actuator 107R, the elbow joint yaw-axis actuator 108R, the wrist joint pitch-axis actuator 110R, and the hand joint roll-axis actuator 113R. Then, maintaining the actuators 104R, 106R, 107R, 108R, 110R, and 113R at the angle shown in FIG. 10A can maintain a basic holding posture. On the other hand, both of the shoulder joint roll-axis actuator 105R and the wrist joint roll-axis actuator 109R do not maintain the rotation angles because the rotation axis directions of both actuators corresponds with the direction of gravity (the actuators which do not maintain the rotation angle are shown in gray in FIG. 10A). Accordingly, when external force acts on the right arm, the actuators 105R and 109R rotate around the rotation axes to enable the right arm to slip out of the external force while horizontally holding the object 120 at shoulder level. This can soften the shock of the collision with an individual or an object.

Note that the actuators of which the rotation axis directions do not correspond with the direction of gravity such as the shoulder joint pitch-axis actuator 104R, the elbow joint pitch-axis actuator 107R, the wrist joint pitch-axis actuator 110R, and the hand joint roll-axis actuator 113R preferably maintain the rotation angles as shown in FIG. 10B, otherwise it would be difficult for the right arm to hold the object 120 at shoulder level or horizontally.

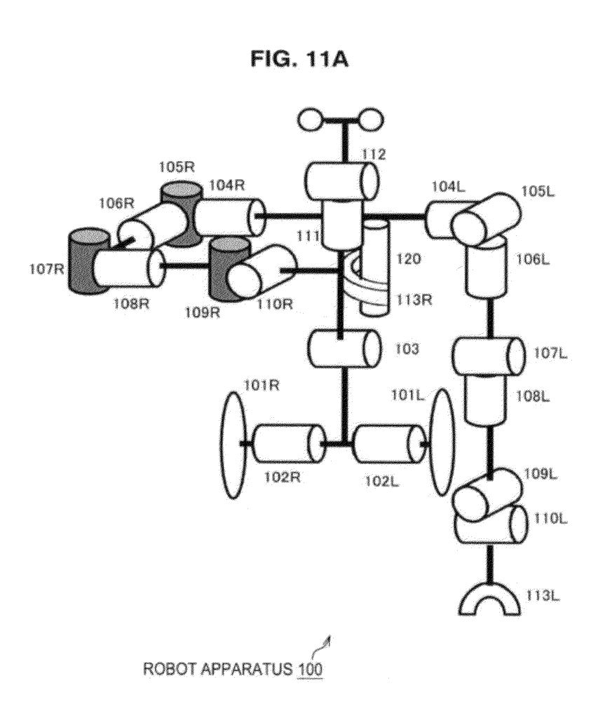

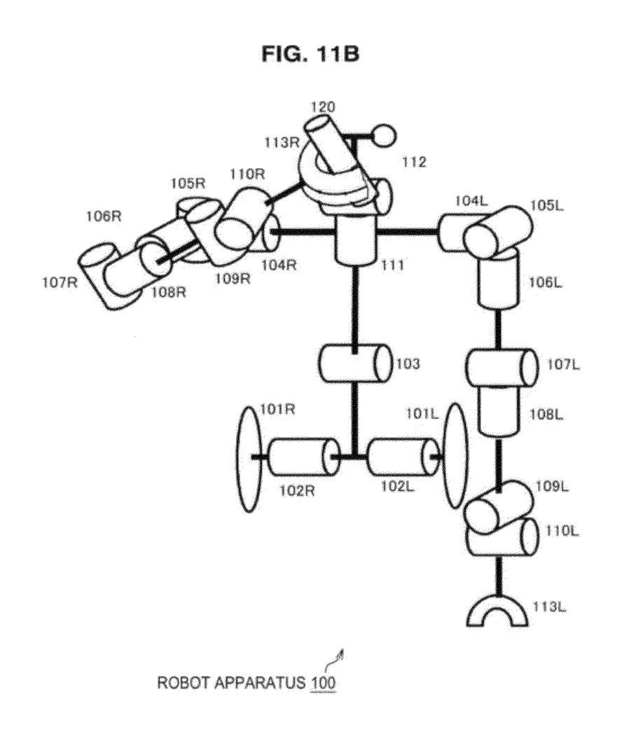

FIG. 11A also shows the robot apparatus 100 horizontally holding the object 120 at shoulder level while bending its elbow. The robot apparatus 100 holds the object 120 with its right hand, putting the object in the hand joint roll-axis actuator 113R as shown in FIG. 11A. To horizontally hold the arm part from the shoulder joint to the tip, the shoulder joint pitch-axis actuator 104R rotates only 90 degrees from a vertical direction to rotate the shoulder joint yaw-axis actuator 106R 90 degrees, the elbow joint pitch-axis actuator 107R rotates only 90 degrees from the angle shown in FIG. 2, and the elbow joint yaw-axis actuator 108R rotates 90 degrees. The other joints are at the same angles as those shown in FIG. 1.

The posture of the robot apparatus 100 shown in FIG. 11A is also one of basic safety stop postures because the rotation axis direction of at least one of the actuators corresponds with the direction of gravity. The actuators constitute the right arm that holds the object. In the case shown in FIG. 11A, the shoulder joint roll-axis actuator 105R, the elbow joint pitch-axis actuator 107R and the wrist joint roll-axis actuator 109R do not maintain the rotation angles because the rotation axis directions of the three actuators correspond with the direction of gravity (the actuators which do not maintain the rotation angle are shown in gray in FIG. 11A). Accordingly, when external force acts on the right arm, the actuators 105R, 107R, and 109R rotate around the rotation axes to enable the right arm to slip out of the external force while horizontally holding the object 120 at shoulder level. This can soften the shock of the collision with an individual or an object.

Note that the actuator of which rotation axis direction does not correspond with the direction of gravity such as the shoulder joint yaw-axis actuator 106R preferably maintains the rotation angle, otherwise it would be difficult for the right arm to hold the object 120 at shoulder level or horizontally as shown in FIG. 11B.

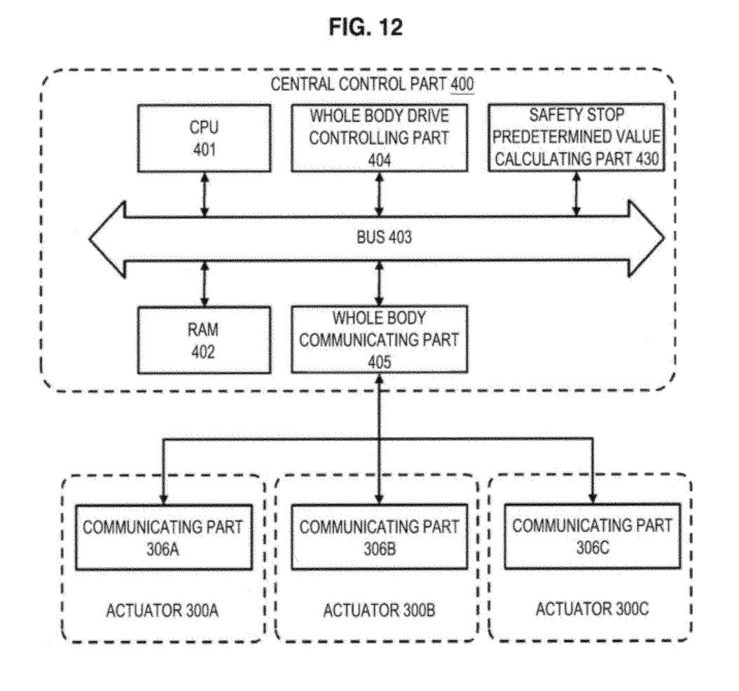

FIG. 12 shows another exemplary structure of the central control part 400 generally controlling the behaviors of the whole robot apparatus 100 shown in FIGS. 1 and 2. The CPU 401 generally controls the behaviors of the whole robot apparatus through the bus 403.

The whole body communicating part 405 of the central control part 400 intercommunicates with the communicating part 306 of each shaft through, for example, a wired LAN such as an Ethernet (registered trademark), a general interface such as a USB, or a wireless LAN specified by IEEE802.11 or the like. The CPU 401 can give a desired torque value of the actuator 300 of each shaft because the CPU 401 can communicate with the microcomputer (described above) of each shaft through the whole body communicating part 405 and the communicating part 306 of each shaft. The microcomputer of each shaft can transmit the current output torque, joint angle, and joint angle speed of the actuator 300 to the CPU 401.

The CPU 401 executes a program expanded into the RAM 402 and performs, together with the whole body drive controlling part 404, a control operation for coordinating the whole body to calculate the desired torque value for every joint.

Furthermore, a safety stop predetermined value calculating part 430 calculates the posture of the robot apparatus 100 based on the joint angle to find the angle value to be stopped of the actuator 300 of each shaft and the predetermined value for a safety stop indicating the ON/OFF of the brake part 308. The safety stop predetermined value calculating part 430 calculates a predetermined value for a safety stop according to, for example, the following procedures.

(1) The current tip position is calculated by an inverse kinematics calculation. (2) The current tip position is compared with each tip position of basic safety stop postures to select the closest tip position of the basic safety stop postures from the current tip position. To compare them to each other, the distance between the current tip position and each tip position of basic safety stop postures is calculated. (3) The closest tip position is selected among some close tip positions. The rotation angles of the close tip positions are compared with the rotation angle of the current tip position.

When receiving a predetermined value for a safety stop from the central control part 400 (described below), the driving part 304 of the actuator 300 safely stops the actuator 300 of each shaft based on the predetermined value for a safety stop in an emergency, for example, a communication fault with the central control part 400.

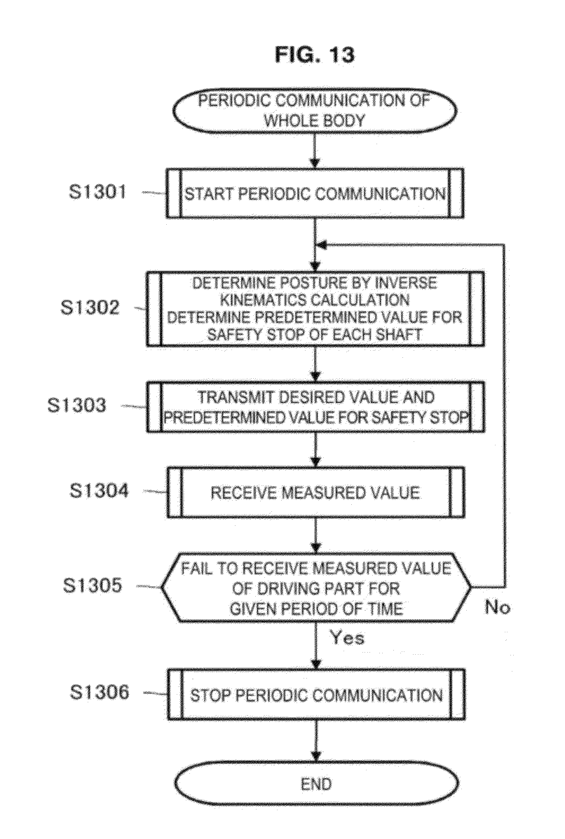

The procedures of a periodic communication of the whole body by the central control part 400 have been already described with reference to FIG. 5. On the other hand, FIG. 13 is a flowchart showing procedures of a periodic communication of the whole body, including transmitting a predetermined value for a safety stop.

The whole body communicating part 405 starts a periodic communication in step S1301. After that, the process goes to step S1302.

The central control part 400 inverse-kinematically calculates the posture of the robot apparatus 100 at the whole body drive controlling part 404 and finds the predetermined value for a safety stop based on the posture of the robot apparatus 100 obtained by the safety stop predetermined value calculating part 430 in step S1302.

The central control part 400 performs a periodic communication to transmit the desired value and the predetermined value for a safety stop to the actuator 300 of each shaft in step S1303.

Next, the central control part 400 receives the measured values such as an output torque, a joint angle, and a joint angle speed from the actuator 300 of each shaft at the periodic communication in step S1304.

Next, the central control part 400 determines in step S1305 whether the central control part 400 has failed to receive the measured values such as an output torque, a joint angle, and a joint angle speed from the actuator 300 of each shaft during a given period of time. The central control part 400 detects the failure to receive the measured values when the central control part 400 has failed to receive the measured values from at least one of the actuators 300 during a given period of time, or the count value that is included in the received result and is supposed to change every time has not been updated although the central control part 400 has received the measured values.

When the central control part 400 has received the measured values from every actuator 300 (“No” in step S1305), the process goes back to step S1302. On the other hand, when the central control part 400 detects the failure to receive the measured values from at least one of the actuators 300 (“Yes” in step S1305), the process goes to step S1306.

The central control part 400 stops the periodic communication in step S1306. When finding a shaft that fails to communicate, namely, a shaft that fails to receive the desired value, the central control part 400 stops the periodic communication of the whole body because of danger.

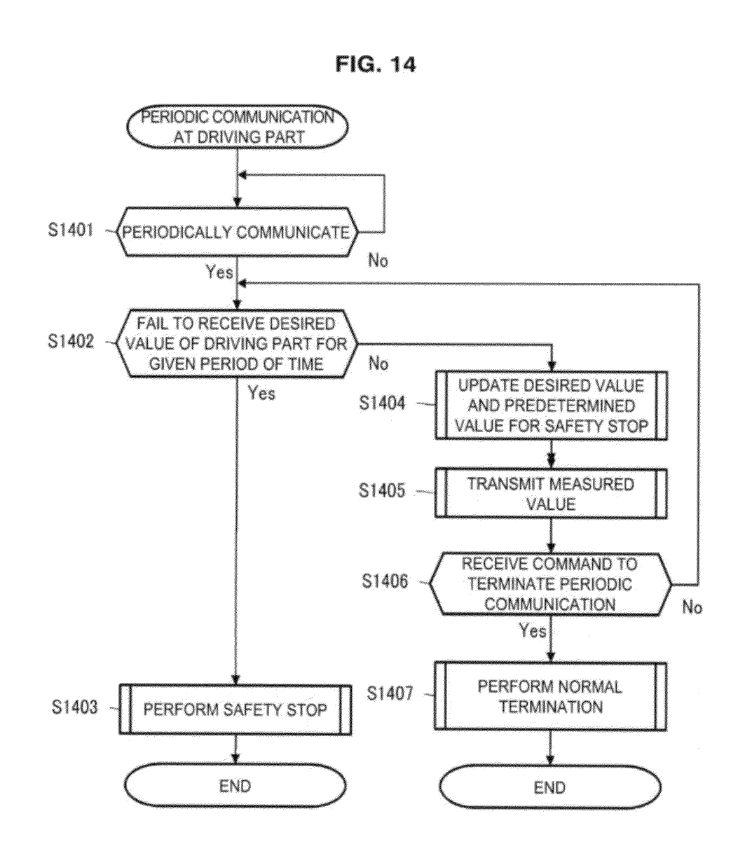

The procedures of a periodic communication executed by the actuator 300 of each shaft according to a periodic communication of the whole body by the central control part 400 have been already described with reference to FIG. 6. On the other hand, FIG. 14 is a flowchart showing procedures of a periodic communication executed by the actuator 300 of each shaft, including updating a predetermined value for a safety stop.

First, the actuator 300 of each shaft determines in step S1401 whether a periodic communication has started. Then, the process goes back to step S1401 to wait for the start of a periodic communication when a periodic communication has not started (“No” in step S1401). On the other hand, the process goes to step S1402 when a periodic communication has started (“Yes” in step S1401).

The actuator 300 of each shaft determines in step S1402 whether the actuator 300 of each shaft has failed to receive the desired torque value of the driving part from the central control part 400 during a given period of time at the periodic communication. When the actuator 300 of each shaft has received the desired torque value from the central control part 400 (“No” in step S1402), the process goes to step S1404 as a normal reception has been done.

The actuator 300 updates its desired torque value and predetermined value for a safety stop with the latest values received from the central control part 400 as a normal reception in step S1404. The actuator 300 then measures the angle, angle speed, and torque of the joint shaft and transmits the measured values to the central control part 400 in step S1405.

Next, the actuator 300 determines in step S1406 whether the actuator 300 has received a command to terminate the periodic communication from the central control part 400. The process then goes back to step S1402 to continue the periodic communication with the central control part 400 when the actuator 300 has not received a command to terminate the periodic communication from the central control part 400 (“No” in step S1406). On the other hand, the process goes to step S1407, when the actuator 300 has received a command to terminate the periodic communication from the central control part 400 (“Yes” in step S1406).

A normal termination is performed in step S1407. Specifically, the actuator 300 performs a normal termination, receiving a desired torque value or a desired positional value necessary to perform the normal termination from the central control part 400.

Further, the process goes to step S1403, when the actuator 300 has failed to receive a desired torque value from the central control part 400 during a given period of time at the periodic communication (“Yes” in step S1402). A safety stop is carried out when the actuator 300 fails to communicate with the central control part 400 in step S1403. The actuator 300 of each shaft independently performs a safety stop when failing to communicate with the central control part 400.

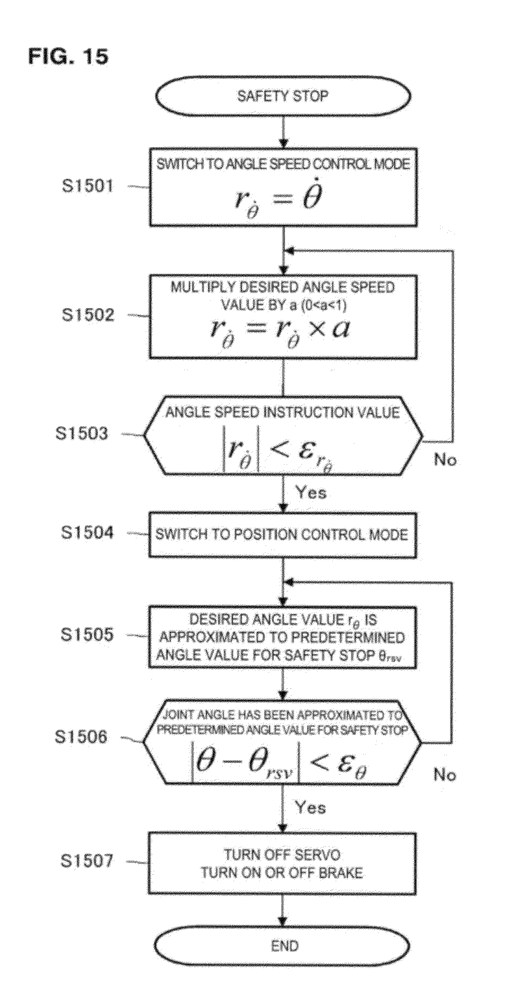

FIG. 15 is a flowchart showing procedures of a safety stop independently executed by the actuator 300 of each shaft in step S1403 of the flowchart shown in FIG. 14.

After the start of a safety stop, the current angle speed is substituted into the current desired angle speed value as shown in the above-mentioned expression (1) to switch the control mode from the torque control mode to the speed control mode in step S1501.

To stop the behavior of the robot apparatus 100, the desired angle speed value is approximated to zero in time order in step S1502. Specifically, the desired angle speed value is multiplied by a constant a (where 0<a<1) one time each control period as shown in the above-mentioned expression (2) to approximate the desired angle speed value to zero.

The actuator 300 then determines at each control period in step S1503 whether the absolute value of the calculated desired angle speed value has been sufficiently approximated to zero. When the absolute value of the desired angle speed value is equal to or larger than a sufficiently small positive number ε_{rθ} (“No” in step S1503), the process goes back to step S1502 to repeat further approximating the desired angle speed value to zero.

The process goes to step S1504, when the absolute value of the desired angle speed value is smaller than a sufficiently small positive number ε_{rθ} as shown in the above-mentioned expression (3) (“Yes” in step S1503). Repeating steps S1502 and S1503 can stop the behavior of the robot apparatus 100.

Next, the current joint angle θ is substituted into the desired angle value r_{θ} to switch the control mode to the position control mode in step S1504.

Next, the desired angle value r_{θ} is approximated to a predetermined angle value for a safety stop θᵣₛᵥ received from the central control part 400 in time order in step S1505. For example, a straight-line interpolation, a sin interpolation, and a spline interpolation can be used as the algorithm for the approximation.

The actuator 300 then determines at each control period in step S1506 whether the updated joint angle θ has been approximated to the predetermined angle value for a safety stop θᵣₛᵥ. When the absolute value of the difference obtained by subtracting the predetermined angle value for a safety stop θᵣₛᵥ from the current joint angle θ is smaller than a sufficiently small positive number ε_{θ} as shown in the following expression (6) (“Yes” in step S1506), the actuator 300 determines that the current joint angle θ has been approximated to the predetermined angle value for a safety stop θᵣₛᵥ and the process goes to step S1507.

|θ−θᵣₛᵥ|<ε_{θ} (6)

On the other hand, the process goes back to step S1505 to further approximate the desired angle value r_{θ} to the predetermined angle value for a safety stop θᵣₛᵥ by, for example, a straight-line interpolation when the actuator 300 determines that the current joint angle θ has not been approximated to the predetermined angle value for a safety stop θᵣₛᵥ (“No” in step S1506).

The ON/OFF of the brake part 308 of each actuator is set based on a predetermined brake value for a safety stop in step S1507.

The brake part 308 is activated based on the setting of the brake part 308 when the servo of each actuator is powered off in step S1507. The actuator 300 is maintained at the current joint angle when the brake part 308 is ON and is not maintained at the current joint angle when the brake part 308 is OFF.

The safety stop shown in FIG. 15 ensures the safety at a collision while the robot apparatus 100 holds an object or maintains its tip position.

(1) A robot apparatus including:

actuators for driving joint shafts and measuring at least one of a joint angle and a joint angle speed of each of the joint shafts; and

a central control part for controlling each of the actuators,

wherein the central control part performs a periodic communication at predetermined control periods and the periodic communication includes transmitting a desired control value from the central control part to each of the actuators and transmitting a measured value from each of the actuators to the central control part,

wherein the central control part stops the periodic communication in response to an occurrence of an actuator that has failed to receive the measured value during a given period of time in the periodic communication, and wherein each of the actuators performs a safety stop in response to an event where the actuator has not received the desired control value in the periodic communication during a given period of time.

(2) A robot apparatus including:

actuators for driving joint shafts and measuring torque and at least one of a joint angle and a joint angle speed of each of the joint shafts; and

a central control part for controlling each of the actuators,

wherein the central control part performs a periodic communication at predetermined control periods and the periodic communication includes transmitting a desired control value from the central control part to each of the actuators and transmitting a measured value from each of the actuators to the central control part,

wherein the central control part stops the periodic communication in response to an occurrence of an actuator that has failed to receive the measured value during a given period of time in the periodic communication, and

wherein each of the actuators performs a safety stop in response to an event where the actuator has not received the desired control value in the periodic communication during a given period of time.

(3) The robot apparatus according to (1) or (2),

wherein each of the actuators approximates a desired angle speed value to zero in time order under an angle speed control mode, also approximates a speed control gain to zero in time order, and then stops a servo as the safety stop.

(4) The robot apparatus according to (I) or (2), further including:

an arm part,

wherein each of the actuators includes a brake part for maintaining a rotation angle at the safety stop, and

wherein the brake part does not maintain the rotation angle of an actuator of which rotation axis direction corresponds with the direction of gravity at the safety stop although the brake part maintains the rotation angle of an actuator of which rotation axis direction does not correspond with the direction of gravity, and the actuators are included in the arm part.

(5) The robot apparatus according to (1) or (2),

wherein each of the actuators includes a brake part for maintaining a rotation angle at the safety stop,

wherein the central control part finds an angle value to safely stop each of the actuators and a predetermined value for a safety stop indicating an ON/OFF of the brake part and performs the periodic communication to transmit the values, and

wherein each of the actuators updates the predetermined value for a safety stop at each periodic communication to perform the safety stop according to the predetermined value for a safety stop.

(6) The robot apparatus according to (5),

wherein the central control part inverse-kinematically calculates the posture of the robot apparatus, and calculates the predetermined value for a safety stop based on the posture.

(7) The robot apparatus according to (5),

wherein, as the safety stop, each of the actuators approximates a desired angle speed value to zero in time order under an angle speed control mode, also switches the mode to a position control mode, approximates the joint angle to the predetermined value for a safety stop in time order, and then stops a servo.

(8) A method for controlling a robot apparatus, including:

performing a periodic communication between actuators and a central control part, the periodic communication including transmitting a desired control value from the central control part to each of the actuators and transmitting a measured value from each of the actuators to the central control part at predetermined control periods, each of the actuators driving a joint shaft and also measuring at least one of a joint angle and a joint angle speed of the joint shaft, the central control part controlling each of the actuators;

stopping, by the central control part, a periodic communication in response to an occurrence of an actuator that has failed to receive the measured value for a given period of time in the periodic communication; and

performing a safety stop in response to an event where the actuator has not received the desired control value during a given period of time in the periodic communication.

(9) A method for controlling a robot apparatus, including:

performing a periodic communication between actuators and a central control part, the periodic communication including transmitting a desired control value from the central control part to each of the actuators and transmitting a measured value from each of the actuators to the central control part at predetermined control periods, each of the actuators driving a joint shaft and also measuring at least one of a joint angle and a joint angle speed of the joint shaft, the central control part controlling each of the actuators;

stopping, by the central control part, a periodic communication in response to an occurrence of an actuator that has failed to receive the measured value for a given period of time in the periodic communication; and

performing a safety stop in response to an event where the actuator has not received the desired control value during a given period of time in the periodic communication.

It should be understood by those skilled in the art that various modifications, combinations, sub-combinations and alterations may occur depending on design requirements and other factors insofar as they are within the scope of the appended claims or the equivalents thereof.

The gist of the technique disclosed herein is not limited to the embodiments applied to a robot apparatus that has two opposed wheels although the embodiments have been mainly described herein. The technique can be also applied to a robot apparatus that has another kind of transportation or that does not have transportation.

Of course, the technique can be also applied to robot apparatuses for various purposes including an industrial robot although the embodiments of a household robot apparatus have been mainly described herein.

In short, the content described herein should not be limitedly interpreted because examples of the technique have been disclosed herein. To judge the gist of the technique disclosed herein, the scope of the appended claims should be taken into consideration.

The present disclosure contains subject matter related to that disclosed in Japanese Priority Patent Application JP 2011-122908 filed in the Japan Patent Office on May 31, 2011, the entire content of which is hereby incorporated by reference.

What is claimed is:

1. A robot apparatus comprising:
actuators for driving joint shafts and measuring at least one of a joint angle and a joint angle speed of each of the joint shafts; and
a central control part for controlling each of the actuators,
wherein the central control part performs a periodic communication at predetermined control periods and the periodic communication includes transmitting a desired control value from the central control part to each of the actuators and transmitting a measured value from each of the actuators to the central control part,
wherein the central control part stops the periodic communication in response to an occurrence of an actuator that has failed to receive the measured value during a given period of time in the periodic communication, and
wherein each of the actuators performs a safety stop in response to an event where the actuator has not received the desired control value in the periodic communication during a given period of time.

2. A robot apparatus comprising:
actuators for driving joint shafts and measuring torque and at least one of a joint angle and a joint angle speed of each of the joint shafts; and
a central control part for controlling each of the actuators,
wherein the central control part performs a periodic communication at predetermined control periods and the periodic communication includes transmitting a desired control value from the central control part to each of the actuators and transmitting a measured value from each of the actuators to the central control part,
wherein the central control part stops the periodic communication in response to an occurrence of an actuator that has failed to receive the measured value during a given period of time in the periodic communication, and
wherein each of the actuators performs a safety stop in response to an event where the actuator has not received the desired control value in the periodic communication during a given period of time.

3. The robot apparatus according to claim 1,
wherein each of the actuators approximates a desired angle speed value to zero in time order under an angle speed control mode, also approximates a speed control gain to zero in time order, and then stops a servo as the safety stop.

4. The robot apparatus according to claim 1, further comprising:
an arm part,
wherein each of the actuators includes a brake part for maintaining a rotation angle at the safety stop, and
wherein the brake part does not maintain the rotation angle of an actuator of which rotation axis direction corresponds with the direction of gravity at the safety stop although the brake part maintains the rotation angle of an actuator of which rotation axis direction does not correspond with the direction of gravity, and the actuators are included in the arm part.

5. The robot apparatus according to claim 1,
wherein each of the actuators includes a brake part for maintaining a rotation angle at the safety stop,
wherein the central control part finds an angle value to safely stop each of the actuators and a predetermined value for a safety stop indicating an ON/OFF of the brake part and performs the periodic communication to transmit the values, and
wherein each of the actuators updates the predetermined value for a safety stop at each periodic communication to perform the safety stop according to the predetermined value for a safety stop.

6. A method for controlling a robot apparatus, comprising:
performing a periodic communication between actuators and a central control part, the periodic communication including transmitting a desired control value from the central control part to each of the actuators and transmitting a measured value from each of the actuators to the central control part at predetermined control periods, each of the actuators driving a joint shaft and also measuring at least one of a joint angle and a joint angle speed of the joint shaft, the central control part controlling each of the actuators;
stopping, by the central control part, a periodic communication in response to an occurrence of an actuator that has failed to receive the measured value for a given period of time in the periodic communication; and
performing a safety stop in response to an event where the actuator has not received the desired control value during a given period of time in the periodic communication.

7. A method for controlling a robot apparatus, comprising:
performing a periodic communication between actuators and a central control part, the periodic communication including transmitting a desired control value from the central control part to each of the actuators and transmitting a measured value from each of the actuators to the central control part at predetermined control periods, each of the actuators driving a joint shaft and also measuring at least one of a joint angle and a joint angle speed of the joint shaft, the central control part controlling each of the actuators;
stopping, by the central control part, a periodic communication in response to an occurrence of an actuator that has failed to receive the measured value for a given period of time in the periodic communication; and
performing a safety stop in response to an event where the actuator has not received the desired control value during a given period of time in the periodic communication.
